(19) United States
(12) Patent Application Publication
(10) Pub. No.: US 2026/0057617 A1
(43) Pub. Date: Feb. 26, 2026

(54) THREE-DIMENSIONAL INFORMATION PROCESSING DEVICE AND THREE-DIMENSIONAL INFORMATION PROCESSING METHOD

(71) Applicant: JVCKENWOOD Corporation, Kanagawa (JP)

(72) Inventor: Etsuro MOMIYAMA, Yokohama-shi (JP)

(21) Appl. No.: 19/375,929

(22) Filed: Oct. 31, 2025

Related U.S. Application Data
(63) Continuation of application No. PCT/JP2024/014371, filed on Apr. 9, 2024.

(30) Foreign Application Priority Data
May 10, 2023 (JP) 2023-077668

(51) Int. Cl. G06T 17/20; G06T 5/30; G06T 7/13; G06V 10/74; G06V 10/77

(52) U.S. Cl. CPC G06T 17/20; G06T 5/30; G06T 7/13; G06V 10/761; G06V 10/7715

(57) ABSTRACT

A three-dimensional information processing device includes an image acquisition unit configured to acquire an image obtained by imaging a subject, a distance information acquisition unit configured to acquire distance information to the subject, a boundary detection unit configured to detect a boundary between the subject and a background on the basis of the acquired image, and a rear surface supplement processing unit configured to derive a function indicating a change in a prescribed direction from the acquired distance information and supplement distance information on a rear surface of the subject on the basis of the derived function and a point on the detected boundary.

### TECHNICAL FIELD

The present invention relates to a three-dimensional information processing device and a three-dimensional information processing method.

### CROSS REFERENCE TO RELATED APPLICATION

Priority is claimed on Japanese Patent Application No. 2023-077668, filed May 10, 2023, the content of which is incorporated herein by reference.

### BACKGROUND ART

In the related art, a three-dimensional shape of an object that exists in the real world is acquired, and a three-dimensional model is modeled on the basis of the acquired three-dimensional shape. There has been a technique in which, to acquire the three-dimensional shape of the object with accuracy, three-dimensional information of a subject is acquired from multiple viewpoints using a plurality of distance measurement cameras. The pieces of three-dimensional information obtained from the plurality of distance measurement cameras are combined to form a single piece of three-dimensional information. By acquiring the three-dimensional information of the subject from multiple viewpoints using the plurality of distance measurement cameras, three-dimensional information with a higher reproduction degree can be acquired compared to when three-dimensional information is acquired from one direction using a single distance measurement camera. An example of a technique in which the pieces of three-dimensional information obtained from the plurality of distance measurement cameras are combined to form a single piece of three-dimensional information is a technique described in Patent Document 1.

### CITATION LIST

### Patent Document

Patent Document 1: Japanese Unexamined Patent Application, First Publication No. H7-174538

### SUMMARY OF INVENTION

According to the related art described above, a single piece of three-dimensional information is combined relative positions between images are calculated using a plurality of pieces of image data captured from multiple viewpoints, coordinate conversion parameters of the image data are obtained, and pasting regarding three-dimensional information is performed on the basis of the coordinate conversion parameters. In this way, the pieces of three-dimensional information are combined to form a single piece of three-dimensional information. In obtaining three-dimensional information with a higher reproduction degree, it is necessary to image the subject from various viewpoints using more distance measurement cameras. When the subject is imaged using more distance measurement cameras, resources are required for combining the three-dimensional information. In particular, when a dynamic three-dimensional shape of the subject is acquired, there is a problem in that it is difficult to acquire the three-dimensional shape in real time. In view of such a problem, it is considered to image the subject using a small number of distance measurement cameras. For example, when the three-dimensional information of the subject is going to be acquired with one distance measurement camera, it is not possible to acquire three-dimensional information of a rear surface of the subject. For this reason, there is a problem in that it is not easy to generate a three-dimensional model based on the subject.

Accordingly, the present embodiment has been accomplished in view of such a situation, and an object of the present embodiment is to provide a three-dimensional information processing device capable of generating a three-dimensional shape of a subject even when a three-dimensional shape of a rear surface of the subject cannot be acquired.
[1] An aspect of the present embodiment is a three-dimensional information processing device including an image acquisition unit configured to acquire an image obtained by imaging a subject, a distance information acquisition unit configured to acquire distance information to the subject, a boundary detection unit configured to detect a boundary between the subject and a background on the basis of the acquired image, and a rear surface supplement processing unit configured to derive a function indicating a change in a prescribed direction from the acquired distance information and supplement distance information on a rear surface of the subject on the basis of the derived function and a point on the detected boundary.
[5] An aspect of the present embodiment is a three-dimensional information processing method including an image acquisition step of acquiring an image obtained by an imaging a subject, a distance information acquisition step of acquiring distance information to the subject, a boundary detection step of detecting a boundary between the subject and a background on the basis of the acquired image, and a rear surface supplement processing step of deriving a function indicating a change in a prescribed direction from the acquired distance information and supplementing distance information on a rear surface of the subject on the basis of the derived function and a point on the detected boundary.

According to the present embodiment, even when a three-dimensional shape of a rear surface of a subject cannot be acquired, a three-dimensional shape of the subject can be generated.

### BRIEF DESCRIPTION OF DRAWINGS

FIG. 1 A schematic configuration diagram showing an example of a functional configuration of a three-dimensional information generation system according to an embodiment.

FIG. 2 A functional configuration diagram showing an example of a functional configuration of a three-dimensional information processing device according to the present embodiment.

FIG. 3 A functional configuration diagram showing an example of a functional configuration of a thinning processing unit according to the present embodiment.

FIG. 4 A diagram illustrating feature point detection processing according to the present embodiment.

FIG. 5 A diagram illustrating thinning processing according to the present embodiment.

FIG. 6 A functional configuration diagram showing an example of a functional configuration of a rear surface supplement processing unit according to the present embodiment.

FIG. 7 A diagram illustrating vertex portion supplement processing according to the present embodiment.

FIG. 8 A diagram illustrating temple portion supplement processing according to the present embodiment.

FIG. 9 A diagram showing an example of point cloud data after thinning processing and road surface supplement processing.

FIG. 10 A diagram illustrating ToF resolution up-conversion according to the present embodiment.

FIG. 11 A diagram showing an example of point cloud data and mesh data according to the present embodiment.

FIG. 12 A flowchart illustrating an example of a series of operations that is performed by the three-dimensional information processing device according to the present embodiment.

FIG. 13 A block diagram showing an example of an internal configuration of the three-dimensional information processing device according to the present embodiment.

### DESCRIPTION OF EMBODIMENTS

A three-dimensional information processing device according to an aspect of the present invention will be hereinafter described in detail with reference to the accompanying drawings while presenting preferred embodiments. The embodiments described below are merely examples, and the embodiments to which the present invention is applied are not limited to the following embodiments. Moreover, the expression “on the basis of XX” means “based on at least XX”, and also includes a case based on another element in addition to XX. The expression “on the basis of XX” is not limited to a case of directly using XX, and also includes a case based on a result of performing calculation or processing on XX. The term “XX” is an optional element (for example, optional information). In the following drawings, for ease of understanding of each configuration, the scale, the number, and the like in each structure may be different from the scale, the number, and the like in an actual structure.

### Embodiment

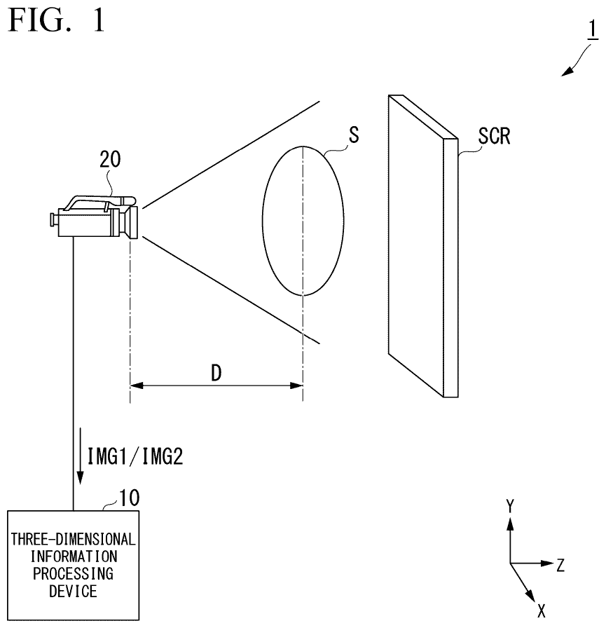

FIG. 1 is a functional configuration diagram showing an example of a functional configuration of a three-dimensional information generation system according to an embodiment. An example of a functional configuration of a three-dimensional information generation system 1 will be described with reference to FIG. 1. In the following description, the posture of each device, the position relationship of each device, and the like in the three-dimensional information generation system 1 may be described according to a three-dimensional rectangular coordinate system of an x axis, a y axis, and a z axis.

The three-dimensional information generation system 1 includes a three-dimensional information processing device 10 and an imaging device 20. The three-dimensional information generation system 1 acquires three-dimensional information of the subject S and executes processing on the basis of the acquired information to generate a three-dimensional model of the subject S by including the three-dimensional information processing device 10 and the imaging device 20. The imaging device 20 images the subject S from a point at a distance D from the subject S in the z-axis direction. A screen SCR such as a blue screen may be disposed behind the subject S. When a three-dimensional shape of the subject S can be easily separated from the background, the screen SCR is not required.

The imaging device 20 is a distance measurement camera that can acquire the three-dimensional information of the subject S. The imaging device 20 acquires the three-dimensional information of the subject S by measuring a distance from the subject S in a two-dimensional manner corresponding to a pictorial image (or a video) to be imaged. The three-dimensional information of the subject S acquired by the imaging device 20 may be a distance image having distance information at each of coordinates in a two-dimensional coordinate system, for example. The imaging device 20 may irradiate the subject S with light using, for example, a time of flight (ToF) method and measure a distance on the basis of a time until reflected light is received. The imaging device 20 outputs, as the acquired three-dimensional information of the subject S, image information IMG1 and distance information IMG2 to the three-dimensional information processing device 10.

In the image information IMG1, image information (for example, an RGB image) obtained by imaging the subject S from a prescribed direction is included. In the distance information IMG2, distance information corresponding to the image information IMG1 is included. The distance information IMG2 includes a plurality of pieces of distance information corresponding to coordinate information on an x-y plane. The coordinate information on the x-y plane in the distance information corresponds to pixels in the image information IMG1. While it is preferable that the distance information is provided for each pixel in the image, a single piece of distance information may be provided for a plurality of pixels. That is, the resolution of the distance information IMG2 on the x-y plane may be lower than the resolution of the image information IMG1.

In the following description, a surface of the subject S on a side on which the imaging device 20 is present may be described as a front surface of the subject S, and a surface of the subject S on a side on which the screen SCR is present may be described as a rear surface of the subject S. The front surface and the rear surface of the subject S are not specified from the shape of the subject S, and are specified by a position relationship between the imaging device 20 and the subject S. Accordingly, it can also be said that image information on the front surface of the subject S is included in the image information IMG1, and distance information on the front surface of the subject S is included in the distance information IMG2.

The three-dimensional information processing device 10 acquires the image information IMG1 and the distance information IMG2 from the imaging device 20. The three-dimensional information processing device 10 generates a three-dimensional model having the three-dimensional shape of the subject S on the basis of the acquired image information IMG1 and distance information IMG2. The three-dimensional model that is generated by the three-dimensional information processing device 10 may be, for example, point cloud data or mesh data. Here, the three-dimensional information generation system 1 acquires information of the subject from one direction with one imaging device 20. Accordingly, the three-dimensional information generation system 1 cannot sufficiently acquire information on the rear surface of the subject S. The three-dimensional information processing device 10 supplements three-dimensional information on the rear surface of the subject S on the basis of information acquired from the imaging device 20 and generates the three-dimensional model. The present embodiment is not necessarily limited to a case where only one imaging device 20 is used, and a plurality of imaging devices 20 may be used.

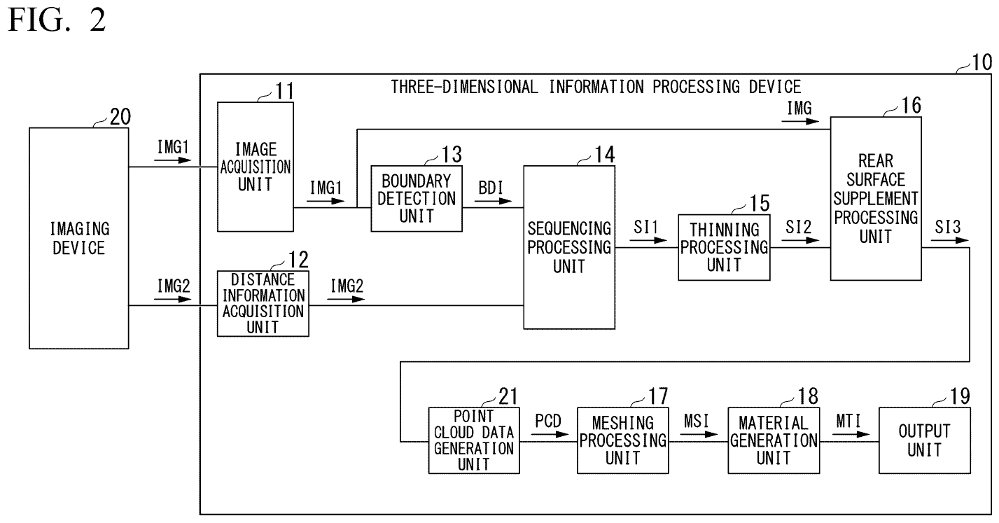

FIG. 2 is a functional configuration diagram showing an example of a functional configuration of the three-dimensional information processing device according to the present embodiment. An example of the functional configuration of the three-dimensional information processing device 10 will be described with reference to FIG. 2.

The three-dimensional information processing device 10 includes an image acquisition unit 11, a distance information acquisition unit 12, a boundary detection unit 13, a sequencing processing unit 14, a thinning processing unit 15, a rear surface supplement processing unit 16, a point cloud data generation unit 21, a meshing processing unit 17, a material generation unit 18, and an output unit 19. Each of these functional units is implemented using an electronic circuit, for example. Each functional unit may include a storage unit such as a semiconductor memory or a hard disk device as necessary. Each function may be implemented by a computer and software.

The image acquisition unit 11 acquires the image information IMG1 obtained by imaging the subject S from the imaging device 20. The image acquisition unit 11 outputs the acquired image information IMG1 to the boundary detection unit 13.

The distance information acquisition unit 12 acquires the distance information IMG2 indicating the three-dimensional shape of the subject S from the imaging device 20. The distance information acquisition unit 12 outputs the acquired distance information IMG2 to the sequencing processing unit 14. The image information IMG1 that is acquired by the image acquisition unit 11 and the distance information IMG2 that is acquired by the distance information acquisition unit 12 are associated with each other by a prescribed method. The prescribed method may be a method on the basis of time information, an identification number, or the like.

The boundary detection unit 13 acquires the image information IMG1 from the image acquisition unit 11. The boundary detection unit 13 detects a boundary between the subject S and a background on the basis of the acquired image information IMG1. For example, when the subject S is a person, the boundary between the subject S and the background is a contour portion of the person. In particular, when the subject S is a face portion of a person, the boundary between the subject S and the background is a contour portion of a face of the person. The contour portion of the face of the person includes a vertex portion that is a boundary between a hair portion and a background portion, or the like. In boundary detection processing that is executed by the boundary detection unit 13, a known object detection algorithm may be used. The boundary detection unit 13 outputs information on the detected boundary as boundary detection information BDI to the sequencing processing unit 14.

The sequencing processing unit 14 acquires the boundary detection information BDI from the boundary detection unit 13, and acquires the distance information IMG2 from the distance information acquisition unit 12. The sequencing processing unit 14 extracts data on the inside of the boundary portion from the distance information IMG2 specified by the boundary detection information BDI and performs sequencing of the extracted data. Through the sequencing processing, information in the background portion other than the subject S from the distance information IMG2, that is, information irrelevant to the three-dimensional information of the subject S is deleted. The sequencing processing unit 14 outputs information obtained as a result of executing the sequencing processing as first sequence information SI1 to the thinning processing unit 15.

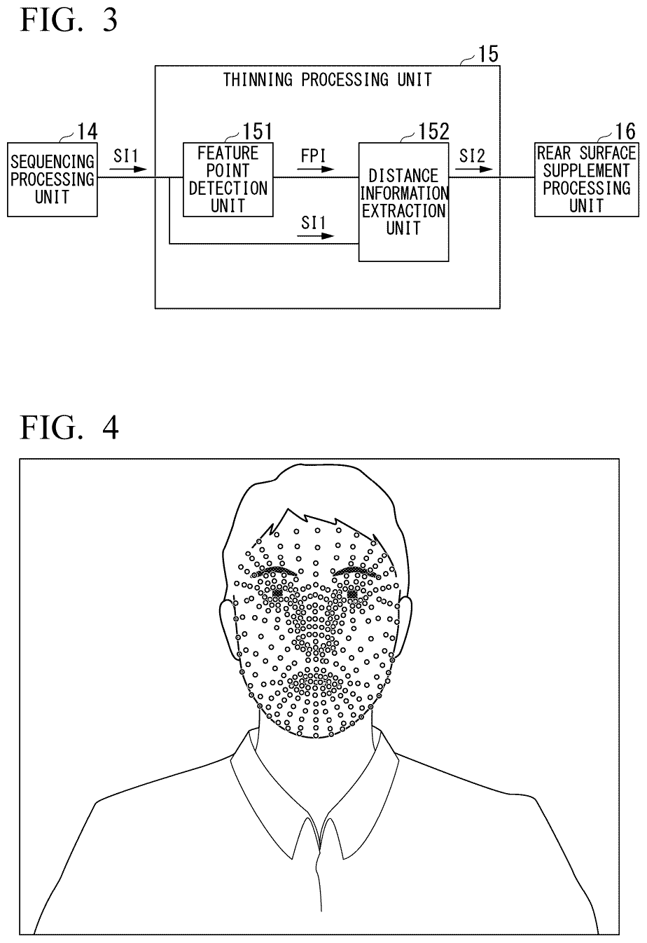

The thinning processing unit 15 acquires the first sequence information SI1 from the sequencing processing unit 14. First, the thinning processing unit 15 extracts feature points of the subject S from image information included in the acquired first sequence information SI1. Next, the thinning processing unit 15 reduces a data amount of the distance information by thinning out the distance information at coordinates other than the extracted feature points. In the following description, the processing that is executed by the thinning processing unit 15 may be described as thinning processing. Details of the thinning processing will be described with reference to FIGS. 3 to 5.

FIG. 3 is a functional configuration diagram showing an example of a functional configuration of the thinning processing unit according to the present embodiment. An example of the functional configuration of the thinning processing unit 15 will be described with reference to FIG. 3. The thinning processing unit 15 includes a feature point detection unit 151 and a distance information extraction unit 152. The feature point detection unit 151 acquires the first sequence information SI1 from the sequencing processing unit 14. In the first sequence information SI1, distance information regarding a portion of the subject S excluding the background portion from the distance information IMG2 acquired by the imaging device 20 is included. The feature point detection unit 151 detects the feature points of the subject S by analyzing the image information regarding the portion of the subject S.

FIG. 4 is a diagram illustrating feature point detection processing according to the present embodiment. The feature point detection processing that is executed by the feature point detection unit 151 will be described with reference to FIG. 4. In FIG. 4, when the subject S is a person, circles are drawn on portions indicating the detected feature points. The feature point is a point that is used in specifying the three-dimensional shape of the subject S, and in other words, may be a point where the three-dimensional shape changes. When the subject S is a face of a person, specifically, 486 feature points may be extracted. In the feature point detection processing, a known feature point detection algorithm may be used. Returning to FIG. 3, the feature point detection unit 151 outputs information on the detected feature points as feature point information FPI to the distance information extraction unit 152. In the feature point information FPI, three-dimensional coordinate information of the feature points is included.

The distance information extraction unit 152 acquires the feature point information FPI from the feature point detection unit 151, and acquires the first sequence information SI1 from the sequencing processing unit 14. The distance information extraction unit 152 executes thinning processing of point cloud data by extracting the distance information of the feature point information FPI from the first sequence information SI1, that is, by discarding information other than the feature point information FPI. When the subject S is a face of a person, the feature point detection unit 151 detects feature points of a face portion. Here, a neck portion and the like other than the face portion may be included in the three-dimensional shape of the subject S. The distance information extraction unit 152 executes the thinning processing only in a range in which the feature points are detected by the feature point detection unit 151, and does not execute thinning processing on other portions (the neck portion and the like other than the face portion).

Here, as a result of the feature point detection processing executed by the feature point detection unit 151, it is preferable that the feature points regarding all points of the subject S are detected. All points of the subject S are all feature points inside the contour of the subject S, that is, all points where the three-dimensional shape changes inside the contour of the subject S. However, when a known feature point detection algorithm is used, it is possible to detect feature points regarding the face portion in the subject S, but feature points for a portion (for example, a vertex portion or a temple portion) other than the face may not be detected. In such a case, it is preferable to expand the feature point detection processing that is executed by the feature point detection unit 151.

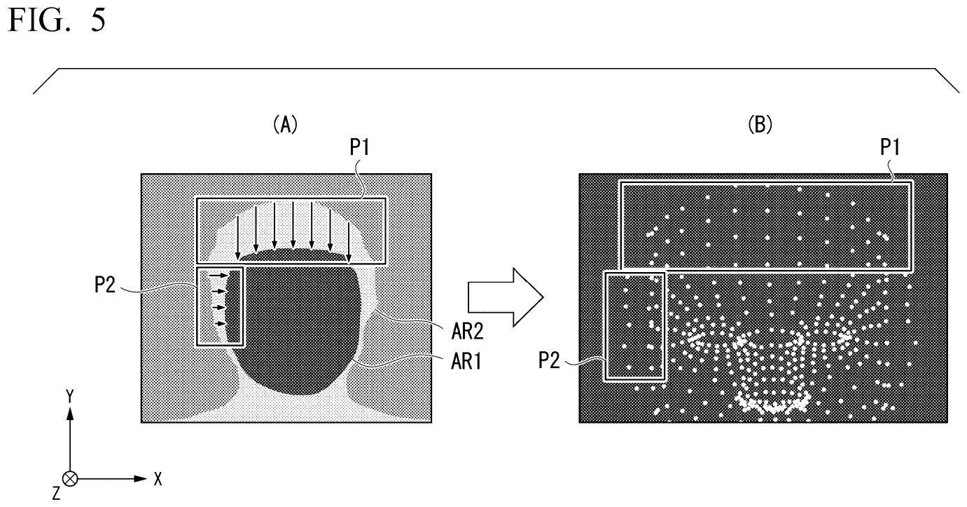

FIG. 5 is a diagram illustrating thinning processing according to the present embodiment. Expanded feature point detection processing and thinning processing will be described.

FIG. 5(A) shows a range AR1 in which the feature points are detected by the feature point detection processing from the distance information IMG2 of the subject S, and a range AR2 indicating the contour of the distance information IMG2 of the subject S. Through the thinning processing of the distance information described above, it is possible to reduce a data amount of point cloud data inside the range AR1 in the range AR2, but it is not possible to reduce a data amount of point cloud data outside the range AR1 in the range AR2. According to the present embodiment, overall thinning processing is executed for the inside of the subject S by the thinning processing executed inside the range AR1 to the range AR2. As the overall thinning processing regarding the inside of the subject S, specifically, thinning processing in the vertex portion and thinning processing in the temple portion are executed. A place where the thinning processing in the vertex portion is executed is shown as P1, and a place where the thinning processing in the temple portion is executed is shown as P2.

A plurality of arrows are shown inside P1. The plurality of arrows shown inside P1 are described at intervals of the feature points that are present in the boundary portion between the range AR1 and the range AR2. In the thinning processing according to the present embodiment, inside P1, the distance information on the shown arrow is left and other distance information is thinned out. Even the distance information on the arrow is thinned out at prescribed intervals. The prescribed interval may be an interval based on an interval of the distance information inside the range AR1. The thinning processing inside P1 is executed in a vertical direction (y-axis direction) as shown in the drawing.

A plurality of arrows are also shown inside P2 similarly. The plurality of arrows shown inside P2 are drawn at intervals of the feature points that are present in the boundary portion between the range AR1 and the range AR2. In the thinning processing according to the present embodiment, inside P2, the distance information on the shown arrow is left, and other distance information is thinned out. Also, the distance information on the arrow is thinned out at prescribed intervals. The prescribed interval may be an interval based on the interval of the distance information inside the range AR1. The thinning processing inside P2 is executed in a horizontal direction (x-axis direction) as shown in the drawing.

FIG. 5(B) shows an example of distance information obtained by the expanded thinning processing described above. As shown in the drawing, it is understood that, even at P1 and P2, there is distance information with a small data amount after the thinning processing is executed. Returning to FIG. 3, the distance information extraction unit 152 outputs information on the distance information obtained as a result of the thinning processing as second sequence information SI2 to the rear surface supplement processing unit 16.

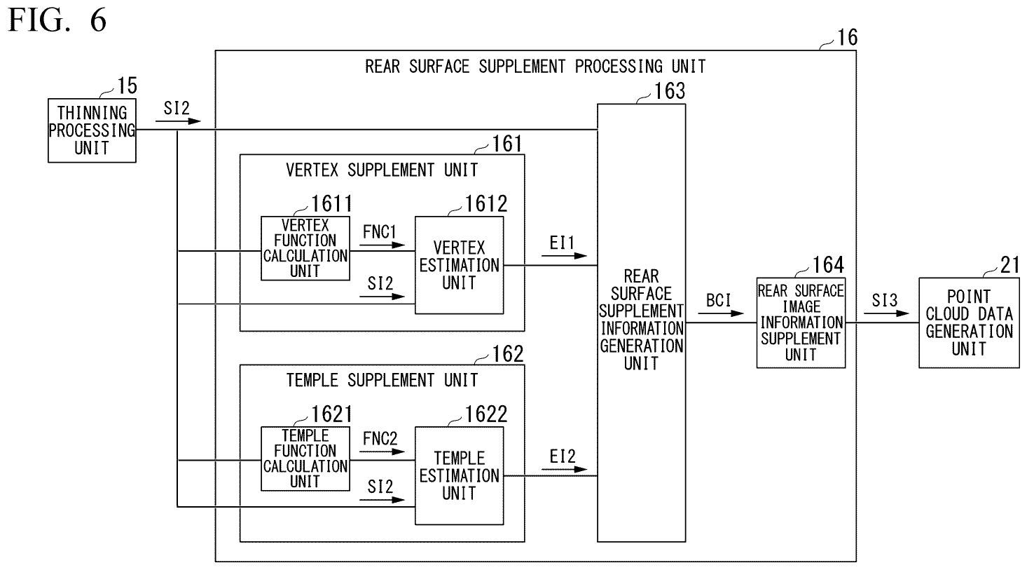

Returning to FIG. 2, the rear surface supplement processing unit 16 acquires the image information IMG1 from the image acquisition unit 11, and acquires the second sequence information SI2 from the thinning processing unit 15. The rear surface supplement processing unit 16 calculates a function indicating a change in a prescribed direction of a point cloud from the acquired second sequence information SI2 (in the following description, also described as derive a function in some cases). The function is a function that passes through three-dimensional coordinates of the feature points detected by the feature point detection unit 151. Specifically, when the subject S is a face portion of a person, the function indicates a change of the face portion of the person on a y-z plane (see FIG. 5). The rear surface supplement processing unit 16 supplements distance information on the rear surface of the subject S on the basis of the calculated function and a point on the boundary detected by the boundary detection unit 13. The rear surface supplement processing unit 16 may supplement the obtained distance information (the distance information on the rear surface of the subject S) with a space thinned out by the thinning processing unit 15. In the following description, the processing that is executed by the rear surface supplement processing unit 16 may be described as road surface supplement processing. Details of the road surface supplement processing will be described with reference to FIGS. 6 to 10.

FIG. 6 is a functional configuration diagram showing an example of a functional configuration of the rear surface supplement processing unit according to the present embodiment. An example of the functional configuration of the rear surface supplement processing unit 16 will be described with reference to FIG. 6. The rear surface supplement processing unit 16 includes a vertex supplement unit 161, a temple supplement unit 162, a rear surface supplement information generation unit 163, and a rear surface image information supplement unit 164.

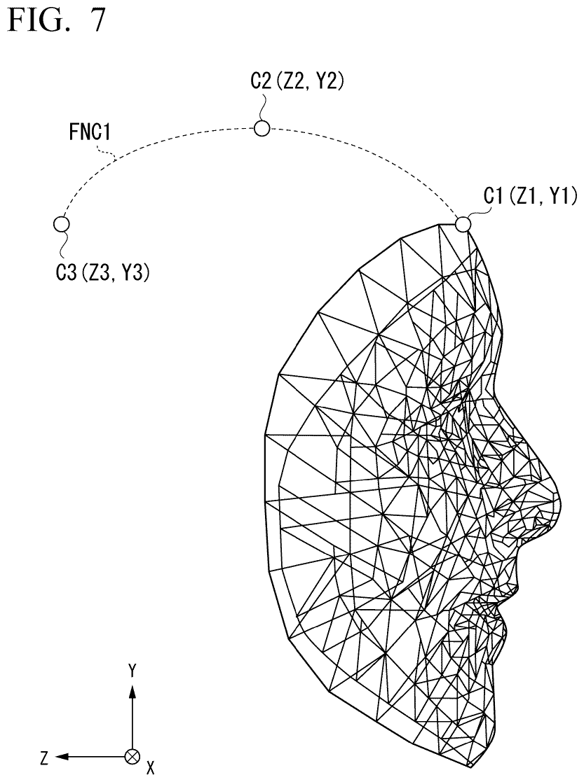

The vertex supplement unit 161 includes a vertex function calculation unit 1611 and a vertex estimation unit 1612. The vertex function calculation unit 1611 acquires the second sequence information SI2 from the thinning processing unit 15. The vertex function calculation unit 1611 calculates a function in a vertex portion. The function that is calculated by the vertex function calculation unit 1611 is a function that passes through the distance information of the subject S in a vertical direction. Specifically, when the subject S is a face portion of a person, the function indicates a change in three-dimensional shape of the face portion of the person on the y-z plane (see FIG. 7), and is a function that passes through a point of a hairline on a forehead, a point of a vertex portion, and a point of an occiput portion on the y-z plane. The function may be, for example, a quadratic function. The vertex function calculation unit 1611 calculates a plurality of functions at prescribed intervals in a transverse direction (x-axis direction). The prescribed interval may be an interval to such an extent that the shape of the subject S can be sufficiently expressed when the three-dimensional shape is generated.

Hereinafter, the processing that is executed by the vertex supplement unit 161 may be described as vertex portion supplement processing.

FIG. 7 is a diagram illustrating the vertex portion supplement processing according to the present embodiment. An example of the function that is obtained by the vertex portion supplement processing will be described with reference to FIG. 7. FIG. 7 is a diagram of the three-dimensional information of the subject S viewed in the x-axis direction. Coordinates C1(Z1, Y1) and coordinates C2(Z2, Y2) are points that are present on the same y-z plane. That is, x coordinates of the coordinates C1 and the coordinates C2 are the same. The coordinates C1 and the coordinates C2 are points on the distance information included in the second sequence information SI2. The vertex function calculation unit 1611 calculates a first function FNC1, for example, on the basis of the coordinates C1 and the coordinates C2. The first function FNC1 may be calculated on the basis of a plurality of points.

Returning to FIG. 6, the vertex function calculation unit 1611 outputs information regarding the calculated function as the first function FNC1 to the vertex estimation unit 1612. In the first function FNC1, information on plurality of functions may be included.

The vertex estimation unit 1612 acquires the second sequence information SI2 from the thinning processing unit 15, and acquires the first function FNC1 from the vertex function calculation unit 1611. The vertex estimation unit 1612 estimates distance information on the rear surface of the subject S on the basis of the first function FNC1 and the distance information included in the second sequence information SI2.

Progressing to FIG. 7, a method for generating distance information on the rear surface of the subject S will be described. Here, the first function FNC1 is a function obtained on the basis of the coordinates C1(Z1, Y1) and the coordinates C2(Z2, Y2) on the distance information included in the second sequence information SI2. As a point on the function, coordinates C3(Z3, Y3) are shown. The coordinates C3 are, that is, information of a point that is on the rear surface of the subject S and cannot be intrinsically acquired from the imaging device 20. In this way, the vertex estimation unit 1612 estimates a three-dimensional shape of the subject S that cannot be intrinsically acquired from the imaging device 20, on the basis of the calculated function.

The distance information on the rear surface of the subject S may be an abnormal value depending on the function calculated by the vertex function calculation unit 1611. Here, when information on what the subject S is is previously known, determination can be made whether the distance information on the rear surface of the subject S is an abnormal value, and when determination is made to be an abnormal value, correction can be performed. For example, when it is previously known that the subject S is a face portion of a person, a range of coordinates that can be practically taken as the rear surface of the person is limited to a prescribed range. Accordingly, the coordinates of the rear surface of the subject S may be estimated to fall within a range of a maximum value and a minimum value of three-dimensional coordinates. The range of the maximum value and the minimum value of the three-dimensional coordinates may be acquired on the basis of a class or the like of the subject S obtained when object detection is performed by the boundary detection unit 13. Returning to FIG. 6, the vertex estimation unit 1612 outputs the estimated distance information on the rear surface of the subject S as first estimation information EI1 to the rear surface supplement information generation unit 163.

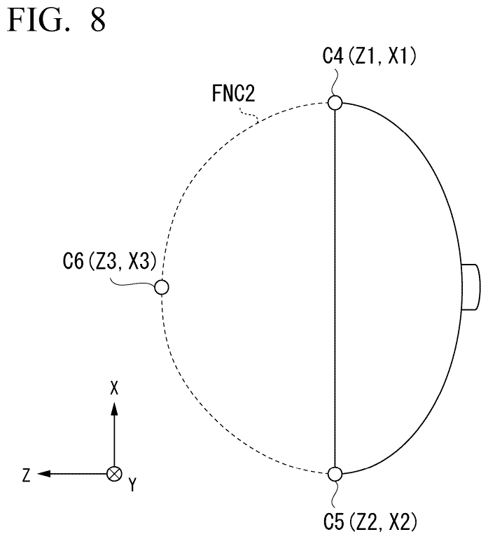

The temple supplement unit 162 includes a temple function calculation unit 1621 and a temple estimation unit 1622. The temple function calculation unit 1621 acquires the second sequence information SI2 from the thinning processing unit 15. The temple function calculation unit 1621 calculates a function in a temple portion. The function that is calculated by the temple function calculation unit 1621 is a function that passes through the distance information of the subject S in the horizontal direction. Specifically, when the subject S is a face portion of a person, the function indicates a change in three-dimensional shape of the face portion of the person on a x-z plane (see FIG. 8), and is function that passes through a point of a hairline on the temple portion, a point of the temple portion (the boundary between the subject and the background), and a point of the occiput portion from the face on the x-z plane. The function may be, for example, a quadratic function. The temple function calculation unit 1621 calculates a plurality of functions at prescribed intervals in a longitudinal direction (y-axis direction). The prescribed interval may be, for example, an interval to such an extent that the shape of the subject S can be sufficiently expressed when the three-dimensional shape is generated. Hereinafter, the processing that is executed by the temple supplement unit 162 may be described as temple portion supplement processing.

FIG. 8 is a diagram illustrating the temple portion supplement processing according to the present embodiment. An example of the function that is obtained by the temple portion supplement processing will be described with reference to FIG. 8. FIG. 8 is a diagram of the three-dimensional information of the subject S view in the y-axis direction. Coordinates C4(Z1, X1) and coordinates C5(Z2, X2) are points that are prevent on the same x-z plane. That is, y coordinates of the coordinates C4 and the coordinates C5 may be the same. The coordinates C4 and the coordinates C5 may be points on the distance information included in the second sequence information SI2. The temple function calculation unit 1621 calculates a second function FNC2 on the basis of the coordinates C4 and the coordinates C5. The second function FNC2 may be calculated on the basis of a plurality of points.

Returning to FIG. 6, the temple function calculation unit 1621 outputs information regarding the calculated function as the second function FNC2 to the temple estimation unit 1622. In the second function FNC2, information regarding a plurality of functions may be included.

The temple estimation unit 1622 acquires the second sequence information SI2 from the thinning processing unit 15, and acquires the second function FNC2 from the temple function calculation unit 1621. The temple estimation unit 1622 estimates the distance information on the rear surface of the subject S on the basis of the second function FNC2 and the distance information included in the second sequence information SI2.

Progressing to FIG. 8, a method for generating the distance information on the rear surface of the subject S will be described. Here, the second function FNC2 is a function obtained on the basis of the coordinates C4(Z1, X1) and the coordinates C5(Z2, X2) on the distance information included in the second sequence information SI2. As a point on the function, coordinates C6(Z3, X3) is shown. The coordinates C6 are, that is, information of a point that is on the rear surface of the subject S and that cannot be intrinsically acquired from the imaging device 20. In this way, the temple estimation unit 1622 estimates the three-dimensional shape that cannot be intrinsically acquired from the imaging device 20, on the basis of the calculated function.

The distance information on the rear surface of the subject S may be an abnormal value depending on the function calculated by the temple function calculation unit 1621. Here, when information on what the subject S is is previously known, determination can be made whether the distance information on the rear surface of the subject S is an abnormal value, and when determination is made to be an abnormal value, correction can be performed. For example, when it is previously known that the subject S is a face portion of a person, a range of coordinates that can be practically taken as the rear surface of the person is limited to a prescribed range. Accordingly, the coordinates of the rear surface of the subject S may be estimated to fall within a range of a maximum value and a minimum value of three-dimensional coordinates described in advance. The range of the maximum value and the minimum value of the three-dimensional coordinates may be acquired on the basis of a class or the like of the subject S obtained when object detection is performed by the boundary detection unit 13. Returning to FIG. 6, the temple estimation unit 1622 outputs the estimated distance information on the rear surface of the subject S as second estimation information EI2 to the rear surface supplement information generation unit 163.

The rear surface supplement information generation unit 163 acquires the second sequence information SI2 from the thinning processing unit 15, acquires the first estimation information EI1 from the vertex supplement unit 161, and acquires the second estimation information EI2 from the temple supplement unit 162. The rear surface supplement information generation unit 163 generates overall distance information including the front surface and the rear surface of the subject S on the basis of the acquired information. Here, in the second sequence information SI2, the distance information of the front surface of the subject S is included. In the first estimation information EI1 and the second estimation information EI2, estimated information of the distance information on the rear surface of the subject S is included. Accordingly, the rear surface supplement information generation unit 163 generates distance information including the three-dimensional information regarding the front surface and the rear surface of the subject S on the basis of these pieces of information. The rear surface supplement information generation unit 163 outputs the generated information as rear surface supplement information BCI to the rear surface image information supplement unit 164.

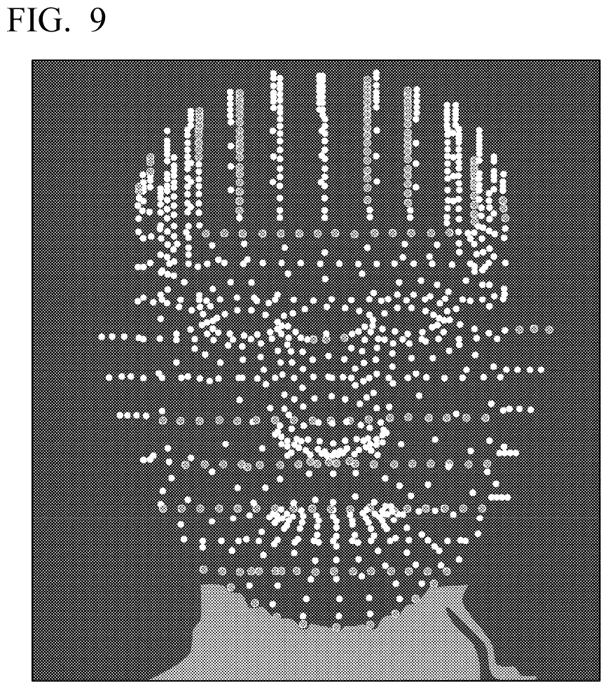

FIG. 9 is a diagram showing an example of distance information after the thinning processing and the road surface supplement processing according to the present embodiment. An example of the rear surface supplement information BCI generated by the rear surface supplement information generation unit 163 will be described with reference to FIG. 9. As shown in the drawing, according to the rear surface supplement information BCI generated by the rear surface supplement information generation unit 163, the distance information of the front surface and the rear surface on the face portion of the person as the subject S can be generated. In the example shown in the drawing, regarding the neck portion of the subject S, distance information is not subjected to thinning processing. However, the present embodiment is not limited to the example, and thinning processing may also be performed on neck data by using the method described with reference to FIG. 5, or the like.

Here, while the distance information on the rear surface of the subject S can be generated by the rear surface supplement information generation unit 163, it is preferable that supplement processing is also executed on an image on the rear surface of the subject S. With the three-dimensional information processing device 10, by providing the rear surface image information supplement unit 164, the supplement processing is also executed on an image on the rear surface of the subject S. Returning to FIG. 6, the rear surface image information supplement unit 164 acquires the image information IMG1 from the image acquisition unit 11, and acquires the rear surface supplement information BCI from the rear surface supplement information generation unit 163. The rear surface image information supplement unit 164 supplements image information on the rear surface of the subject S on the basis of the acquired image information IMG1 on the front surface of the subject S and the distance information of the rear surface of the subject S. The rear surface image information supplement unit 164 may extract color information of, for example, a hair portion on the basis of the image information of the front surface of the subject S, for example, and may supplement image information on the rear surface of the subject S using the extracted color information of the hair portion. The rear surface image information supplement unit 164 supplements the image information on the rear surface of the subject S, and then, outputs data having the distance information of the subject S and the image information as third sequence information SI3 to the point cloud data generation unit 21.

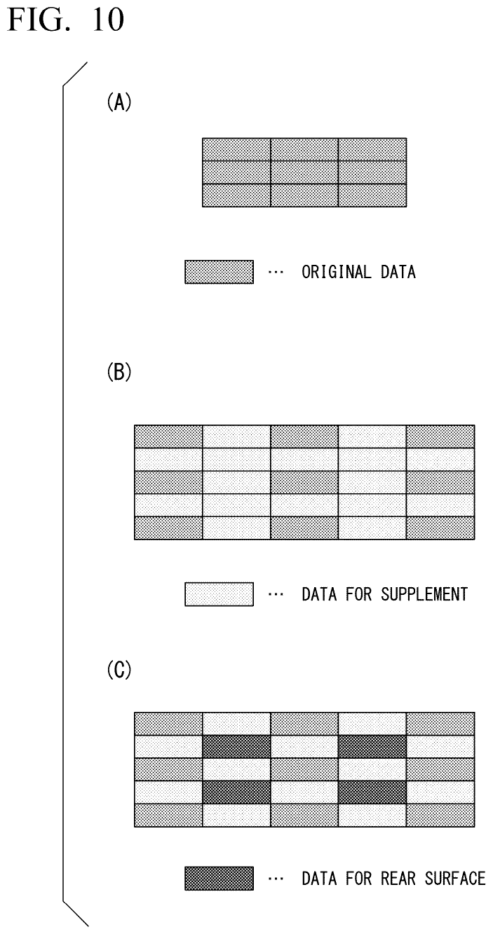

In the present situation, while the resolution of an image sensor is progressing to a high resolution, the resolution of a ToF sensor is not as high as the resolution of the image sensor, and the resolution of the ToF sensor may be low compared to the resolution of the image sensor. In such a case, to use high-resolution image data without discarding image data, it is preferable that the ToF resolution is made to conform to the resolution of the image sensor by up-converting the ToF resolution. Hereinafter, up-conversion of the ToF resolution will be described with reference to FIG. 10.

FIG. 10 is a diagram illustrating up-conversion of a ToF resolution according to the present embodiment. The up-conversion of the ToF resolution according to the present embodiment will be described with reference to FIG. 10. FIG. 10(A) is a schematic view showing an image of distance data that is obtained by a ToF sensor with a low resolution. FIG. 10(B) is a schematic view showing an image when data for supplement is generated using linear supplement or the like and original data shown in FIG. 10(A) is up-converted. Here, a blank portion can be supplemented by up-conversion; however, when meshing is actually performed using such information, an interpolation portion becomes a surface, and a difference according to the presence or absence of supplement processing may not appear. Therefore, according to the present embodiment, ToF data for a rear surface is inserted into a space that occurs because up-conversion is performed. FIG. 10(C) is a schematic view showing an image when ToF data for a rear surface is inserted into a space that occurs because the up-conversion of FIG. 10(B) is performed. By using such a method, not only data for a rear surface but also data for a side surface can be stored in the space that occurs because up-conversion is performed. Therefore, according to the present embodiment, distance information (Depth value) from multiple directions can be stored in one distance image (Depth data), and a data amount can be reduced. By using such a method, it is not necessary to down-convert image information, and it is possible to generate three-dimensional information while keeping a high-resolution of image information.

Returning to FIG. 2, the point cloud data generation unit 21 acquires the third sequence information SI3 from the rear surface supplement processing unit 16. Here, the third sequence information SI3 is the distance information of the subject S in which information regarding the rear surface is supplemented by the rear surface supplement processing unit 16. Accordingly, the point cloud data generation unit 21 generates point cloud data of the subject S in which information regarding the rear surface is supplemented. That is, according to the present embodiment, the sequencing processing or the thinning processing and the supplement processing are executed in a state of the distance information (distance data or Depth value) before the point cloud data is generated. In generate, because a load is high in processing by point cloud data, according to the present embodiment, these kinds of processing are executed in a stage of the distance information before the point cloud data is generated. The point cloud data generation unit 21 outputs generated point cloud data PCD to the meshing processing unit 17.

The meshing processing unit 17 acquires the point cloud data PCD from the point cloud data generation unit 21. The meshing processing unit 17 converts the point cloud data PCD into mesh data composed of a plurality of triangular surfaces.

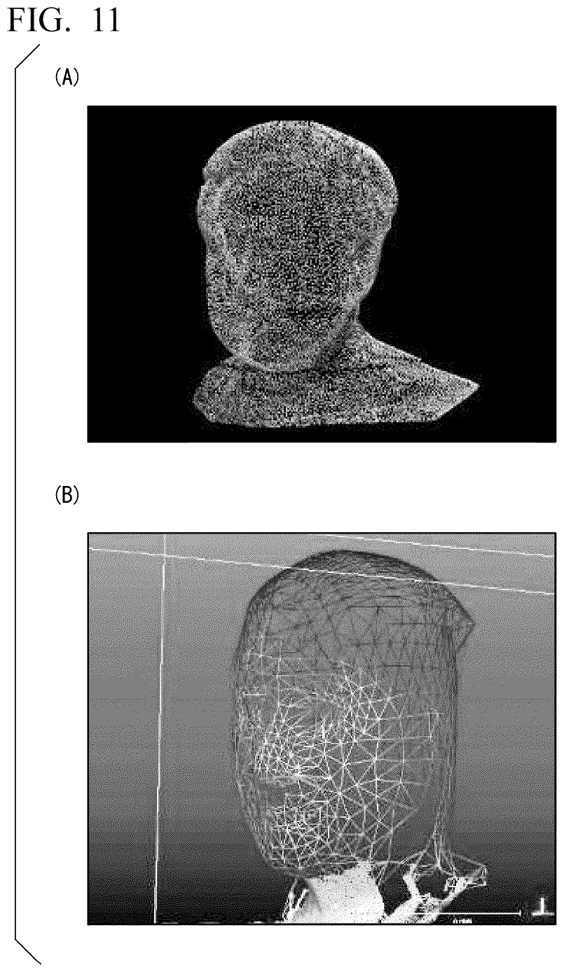

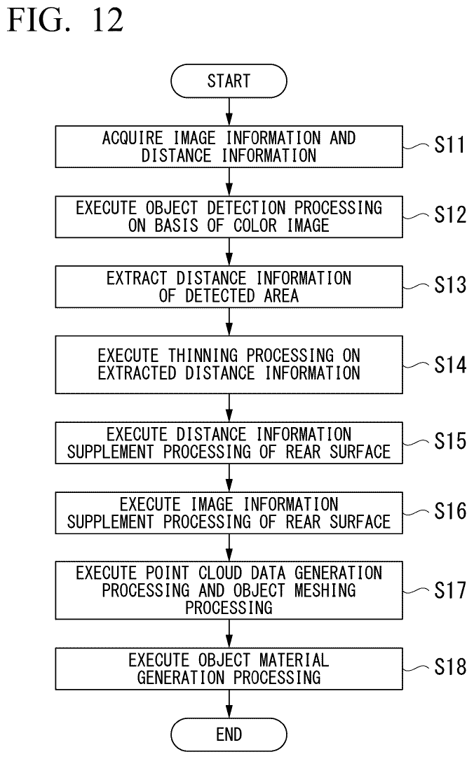

FIG. 11 is a diagram showing an example of point cloud data and mesh data according to the present embodiment. An example of the point cloud data and the mesh data according to the present embodiment will be described with reference to FIG. 11. FIG. 11(A) is an example of point cloud data. The point cloud data PCD that is generated by the point cloud data generation unit 21 is as shown in FIG. 11(A) as an example. FIG. 11(B) is an example of mesh data. The meshing processing unit 17 converts the point cloud data PCD generated by the point cloud data generation unit 21 into mesh data as shown in FIG. 11(B) by executing meshing processing on the basis of the point cloud data PCD. As a method for converting the point cloud data into the mesh data, a known algorithm may be used. Returning to FIG. 2, the meshing processing unit 17 outputs the converted mesh data as mesh information MSI to the material generation unit 18.

The material generation unit 18 acquires the mesh information MSI from the meshing processing unit 17. The material generation unit 18 generates three-dimensional information of the subject S on the basis of the image information IMG1 on the front surface of the subject S and the acquired mesh information MSI. Here, the three-dimensional information and the image information are already included in the mesh information MSI; however, according to the present embodiment, because the point cloud data is thinned out, image information is insufficient, and a resolution of an image of a generated three-dimensional model is low. Accordingly, the material generation unit 18 generates a three-dimensional model with a high-resolution image on the basis of the image information IMG1 captured by the imaging device 20 and the mesh information MSI.

Specifically, the material generation unit 18 first generates an object file (.obj file) from the point cloud data. In generating the object file, a known algorithm may be used. Next, the material generation unit 18 maps apex coordinates of the object film to conform to a color image. Next, the material generation unit 18 generates a material from a mapping result. The material generation unit 18 outputs the generated material as material information MTI to the output unit 19.

The output unit 19 acquires the material information MTI from the material generation unit 18. The output unit 19 outputs the acquired material information MTI to an information processing device (not shown) and the like.

FIG. 12 is a flowchart illustrating an example of a series of operations that is performed by the three-dimensional information processing device according to the present embodiment. A series of flow of a three-dimensional information processing step that is performed by the three-dimensional information processing device 10 will be described with reference to FIG. 12.

First, the image acquisition unit 11 acquires the image information IMG1 from the imaging device 20, and the distance information acquisition unit 12 acquires the distance information IMG2 from the imaging device 20 (Step S11). Next, the boundary detection unit 13 executes object detection processing on the basis of the acquired image information IMG1. The boundary detection unit 13 detects the boundary portion between the subject S and the background by executing the object detection processing (Step S12). Next, the sequencing processing unit 14 performs sequencing by extracting distance information of an area where an object is detected (Step S13). Next, the thinning processing unit 15 executes the thinning processing on the extracted distance information (Step S14). Next, the rear surface supplement processing unit 16 supplements distance information on the rear surface of the subject S, and generates distance information of the entire subject S (Step S15). In addition, the rear surface supplement processing unit 16 also executes the supplement processing on image information of the rear surface (Step S16). Next, the point cloud data generation unit 21 executes point cloud data generation processing on the basis of information in which the distance information and the image information of the rear surface are supplemented. Further, the meshing processing unit 17 executes the meshing processing on the basis of the generated point cloud data (Step S17). Finally, the material generation unit 18 executes material generation processing on the basis of the mesh data and the image information IMG1 of the subject S (Step S18).

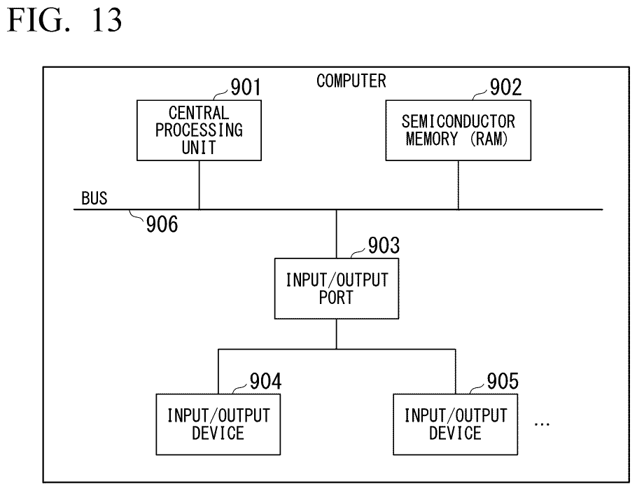

FIG. 13 is a block diagram showing an example of an internal configuration of the three-dimensional information processing device 10 according to the present embodiment. Functions of at least a part of the three-dimensional information processing device 10 may be implemented using a computer. As shown in the drawing, the computer includes a central processing unit 901, a RAM 902, an input/output port 903, input/output devices 904, 905, and the like, and a bus 906. The computer itself may be implemented using an existing technique. The central processing unit 901 executes commands included in a program read from the RAM 902 or the like. The central processing unit 901 writes data to the RAM 902, reads data from the RAM 902, or performs a calculation operation or a logical operation according to each command. The RAM 902 stores data or the program. Each element included in the RAM 902 has an address, and can be accessed using the address. The RAM is an abbreviation of “random access memory”. The input/output port 903 is a port for allowing the central processing unit 901 to exchange data with an external input/output device and the like. The input/output device 904 or 905 is an input/output device. The input/output device 904 or 905 exchanges data with the central processing unit 901 via the input/output port 903. The bus 906 is a common communication path that is used inside the computer. For example, the central processing unit 901 reads or writes data from or to the RAM 902 via the bus 906. For example, the central processing unit 901 accesses the input/output port via the bus 906.

### Overview of Embodiment

According to the embodiment described above, the three-dimensional information processing device 10 includes the image acquisition unit 11 to acquire the image information IMG1 obtained by imaging the subject S, includes the distance information acquisition unit 12 to acquire the distance information IMG2 indicating the three-dimensional shape of the subject S, includes the boundary detection unit 13 to detect the boundary between the subject S and the background on the basis of the acquired image information IMG1, and includes the rear surface supplement processing unit 16 to calculate the function indicating the change in the prescribed direction of the distance information from the acquired distance information IMG2 and supplement the distance information on the rear surface of the subject S on the basis of the calculated function and the point on the detected boundary. That is, according to the present embodiment, the three-dimensional information processing device 10 can generate the three-dimensional shape of the rear surface of the subject S that cannot be intrinsically acquired from the imaging device 20.

According to the above-described embodiment, the thinning processing unit 15 is further provided to extract the feature points from the acquired image information IMG1 and execute the thinning processing of thinning out the distance information other than the extracted feature points to reduce the data amount of the distance information. Further, the rear surface supplement processing unit 16 calculates the function that passes through the three-dimensional coordinates of the feature points and supplements the distance information on the rear surface of the subject S with the space thinned out by the thinning processing unit 15. Here, the resolution of the distance image acquired by the ToF sensor may be lower than the resolution of the image information IMG1. That is, according to the present embodiment, even when the resolution of the distance image is up-converted in conformity with the resolution of the image information IMG1, it is possible to store the distance information of the rear surface without reducing the resolution of the distance image. Thus, according to the present embodiment, it is possible to reduce the data amount.

According to the above-described embodiment, the rear surface supplement processing unit 16 estimates the distance information on the rear surface of the subject S to fall within the range of the maximum value and the minimum value of the three-dimensional coordinates determined in advance. Here, when the distance information of the rear surface is estimated on the basis of the calculated function, the three-dimensional information processing device 10 may erroneously estimate a shape different from an original shape. However, according to the present embodiment, because the maximum value and the minimum value are determined, it is possible to prevent the shape from being estimated to be different from the original shape. The maximum value and the minimum value may be determined according to the class or the like of the subject S when object detection is performed.

According to the above-described embodiment, the rear surface supplement processing unit 16 further includes the rear surface image information supplement unit 164 to supplement the image information on the rear surface of the subject S on the basis of the image information on the front surface of the subject S. Therefore, according to the present embodiment, it is possible to supplement not only the three-dimensional shape on the rear surface of the subject S but also the image information on the rear surface of the subject S.

According to the above-described embodiment, the meshing processing unit 17 is further provided to convert the point cloud data of the subject S with information regarding the rear surface supplemented by the rear surface supplement processing unit 16 into the mesh data composed of a plurality of triangular surfaces, and the material generation unit 18 is further provided to generate the three-dimensional information of the subject S on the basis of the image information IMG1 on the front surface of the subject S and the mesh data. Because the three-dimensional information generated in such a manner is based on the image information IMG1 captured by the imaging device 20, the resolution of the image is high. Therefore, according to the present embodiment, it is possible to generate the three-dimensional model of the subject S with a high reproduction degree.

In the above-described embodiment, a case where the subject S is the face of the person has been described. However, the present embodiment is not limited to this example, and can also be applied to a case where the subject S is other than the face of the person. Another example of the subject S is an animal such as a dog or a cat. Even when the subject S is other than an animal, the present embodiment can be applied. When the subject S is other than an animal, the subject S may be, for example, an automobile, a bicycle, or a building.

In the above-described embodiment, an example where the three-dimensional information regarding the single subject S is generated using information acquired by single imaging with the imaging device 20, that is, the single piece of image information and distance information imaging device 20 has been described. However, the present embodiment is not limited to this example, and three-dimensional information regarding a plurality of subjects S may be generated from information acquired by single imaging with the imaging device 20. In this case, it is possible to generate three-dimensional information of various objects by detecting a plurality of objects through object detection, detecting classes of the detected objects, and using different supplement parameters (calculation expressions) for the detected classes. The parameters for the classes may be made into a database and stored in a prescribed server device or the like.

All or some functions of each of the units provided in each device in the above-described embodiment may be implemented by recording a program for implementing these functions on a computer-readable recording medium and causing a computer system to read and execute the program recorded on the recording medium. The “computer system” used herein includes an OS and hardware such as peripheral equipment.

The “computer-readable recording medium” refers to a portable medium such as a flexible disk, a magneto-optical disc, a ROM, or a CD-ROM, or a storage unit such as a hard disk embedded in the computer system. In addition, the “computer-readable recording medium” may include a medium for dynamically holding the program for a short period of time like a communication line when the program is transmitted via a network such as the Internet or a communication circuit such as a telephone circuit, and a medium that holds the program for a given period of time like a volatile memory inside the computer system serving as a server or a client in such a case. Furthermore, the above-described program may be a program for implementing some of the above-described functions. In addition, the above-described program may be a program capable of implementing the above-described functions in combination with a program already recorded on the computer system.

Although the embodiment of the present invention has been described above, the present invention is not limited to the above-described embodiment, and various changes can be made without departing from the scope of the present invention. Further, each embodiment described above may be suitably combined.

### INDUSTRIAL APPLICABILITY

According to the present invention, it is possible to generate the three-dimensional shape of the subject even when the three-dimensional shape of the rear surface of the subject cannot be acquired.

### REFERENCE SIGNS LIST

1 Three-dimensional information generation system
10 Three-dimensional information processing device
20 Imaging device
S Subject
SCR Screen
IMG image information
PCD Point cloud data
11 Image acquisition unit
12 Distance information acquisition unit
13 Boundary detection unit
14 Sequencing processing unit
15 Thinning processing unit
16 Tear surface supplement processing unit
17 Meshing processing unit
18 Material generation unit
19 Output unit
151 Feature point detection unit
152 Distance information extraction unit
161 Vertex supplement unit
162 Temple supplement unit
163 Rear surface supplement information generation unit
164 Rear surface image information supplement unit
1611 Vertex function calculation unit
1612 Vertex estimation unit
1621 Temple function calculation unit
1622 Temple estimation unit
BDI boundary detection information
SI1 First sequence information
SI2 Second sequence information
SI3 Third sequence information
MSI Mesh information
MTI Material information
FPI Feature point information
FNC1 First function
FNC2 Second function
EI1 First estimation information
EI2 Second estimation information
BCI Rear surface supplement information

What is claimed is:

1. A three-dimensional information processing device comprising:
an image acquisition unit configured to acquire an image obtained by imaging a subject;
a distance information acquisition unit configured to acquire distance information to the subject;
a boundary detection unit configured to detect a boundary between the subject and a background on the basis of the acquired image; and
a rear surface supplement processing unit configured to derive a function indicating a change in a prescribed direction from the acquired distance information and supplement distance information on a rear surface of the subject on the basis of the derived function and a point on the detected boundary.

2. The three-dimensional information processing device according to claim 1, further comprising:
a thinning processing unit configured to extract a feature point from the acquired image and execute thinning processing of reducing a data amount of the distance information by thinning out distance information other than the extracted feature point,
wherein the rear surface supplement processing unit is configured to derive, as the function, a function passing through three-dimensional coordinates of the feature point and supplement the distance information on the rear surface of the subject with a space thinned out by the thinning processing unit.

3. The three-dimensional information processing device according to claim 1,
wherein the rear surface supplement processing unit is configured to estimate such that the distance information on the rear surface of the subject falls within a range of a maximum range and a minimum range of three-dimensional coordinates determined in advance.

4. The three-dimensional information processing device according to claim 1,
wherein the rear surface supplement processing unit further includes a rear surface image information supplement unit configured to supplement image information on the rear surface of the subject on the basis of image information on a front surface of the subject.

5. A three-dimensional information processing method comprising:
an image acquisition step of acquiring an image obtained by an imaging a subject;
a distance information acquisition step of acquiring distance information to the subject;
a boundary detection step of detecting a boundary between the subject and a background on the basis of the acquired image; and
a rear surface supplement processing step of deriving a function indicating a change in a prescribed direction from the acquired distance information and supplementing distance information on a rear surface of the subject on the basis of the derived function and a point on the detected boundary.
